(19) United States
(12) Patent Application Publication
(10) Pub. No.: US 2008/0269299 A1
(43) Pub. Date: Oct. 30, 2008

(54) Soil-Wetting Insecticide

(76) Inventors: Randy Beussink, St. Louis, MO (US); Timothy H. Stoehr, Burr Ridge, IL (US); Jeff Ochampaugh, Overland Park, KS (US); Richard Houghton, Raleigh, NC (US)

Correspondence Address: WILEY REIN LLP, 1776 K. STREET N.W., WASHINGTON, DC, 20006, US

(21) Appl. No.: 12/020,377

(22) Filed: Jan. 25, 2008

Related U.S. Application Data
(60) Provisional application No. 60/897,233, filed on Jan. 25, 2007.

(51) Int. Cl. A01N 43/40; A01P 7/04

(52) U.S. Cl. 514/341

(57) ABSTRACT

A soil-applied composition for controlling turf-damaging pests is an aqueous solution including a neonicotinoid insecticide, such as an imidacloprid-based insecticide, and a nonionic surfactant. The composition may also include a bio-stimulant to aid in turf recovery, a humectant, or both a bio-stimulant and a humectant. An effective amount of the composition may be applied to a region of soil or turf in order to control turf-damaging pests, such as white grubs.

### CROSS-REFERENCE TO RELATED APPLICATIONS

This application claims the benefit of U.S. provisional application No. 60/897,233, filed 25 Jan. 2007, which is hereby incorporated by reference as though fully set forth herein.

### BACKGROUND OF THE INVENTION

a. Field of the Invention

The instant invention relates to controlling turf-damaging pests. In particular, the instant invention relates to a soil-applied insecticide with adjuvants, including amounts of compatible surfactant in excess of about 50% by weight of a nonionic surfactant.

b. Background Art

Insecticides are commonly used in professional turf management as a means to manage and control destructive below-ground insects that feed upon the roots of turf and other ornamental plants. These pests typically cause the most damage to the plants during their larval stage when “grubs” forage on roots below the soil and thatch surface. This feeding damage can be devastating, killing the turf and other plants by cutting off the plants' abilities to uptake needed moisture and nutrients.

Insecticides generally control pests in two different ways: (1) by contact when the insecticide directly contacts the pest and is taken up into the pest; and (2) by ingestion when the pest feeds or forages upon plants that have been treated by an insecticide. Successfully controlling pests with an insecticide requires delivery of a lethal level of the insecticide's active ingredient to the pest before a significant amount of damage occurs.

This process is particularly challenging when pests are protected below the surface by layers of soil and thatch. Since below-ground pests are more protected by soil and thatch, it is very difficult to control such pests with an application targeted at contacting or “spraying” the pest. Therefore, control of below-ground pests is generally more effective by delivering the insecticide in a manner that is ingested by the “grub” while feeding on the plant. Under these circumstances, control is generally more effective while the grub is smaller, since lower doses of the insecticide active ingredient are required to kill less mature grubs, and because the feeding damage is stopped so that the turf can recover and re-growth can repair and restore plant health.

White grubs are among the most destructive insect pests of turf grass, ranking as the number one pest in 2005 surveys of both professional lawn turf managers and golf turf managers. White grubs feed below the soil surface on the roots and rhizomes of commonly used turf grass species and cultivars, and are capable of eliminating the entire root system of the plant. Where abundant, white grubs are capable of destroying large areas of turf in a short period of time.

After hatching from eggs, white grubs begin feeding on the roots and underground stems of turf grasses. The first evidence of injury is localized patches of pale, discolored, and dying grass displaying symptoms of moisture stress. Damaged areas are small at first, but rapidly enlarge and coalesce as grubs grow and expand their feeding range. Turf in such areas will have a spongy feel under foot and can be easily lifted from the soil surface or rolled like a carpet, revealing the C-shaped white grubs underneath. Damage is most apparent in mid-August through early September when white grub feeding activity is greatest.

Although many different insecticides are labeled for application in managing grubs, the market for controlling white grubs is dominated by neonicotinoid insecticides. Of the neonicotinoids, imidacloprid is particularly favored for management of white grubs in turf due to its improved levels of performance over a wider window of application opportunity. Imidacloprid provides both contact- and ingestion-based control of white grubs. Ingestion-based control is possible because imidacloprid is systemic; that is, the insecticide is taken up by the plant and then eaten by the insect when feeding upon the plant.

One challenge in making insecticide application is timing: the application should be made soon enough for the active insecticide ingredient to become available to kill the pest, but before active damage occurs. If applications are made too late, after feeding damage has occurred from active pests, control is diminished because plant roots have been cut and are therefore not as capable of taking up insecticide for pest ingestion. Further, even if the damage is stopped at that time with the insecticide, plants may have difficulty recovering without an adequate root system to take up needed moisture and nutrients for regrowth and repair.

In addition, the insecticide must be properly applied, which typically means spraying the insecticide onto the turf area and using water from irrigation or rainfall to get the insecticide into the soil and soil solution where it can be taken up by the plant and/or come in contact with the pest. Since imidacloprid insecticide is actively degraded by light, it is important to effectively “water in” the insecticide prior to significant photodegradation.

It is known, however, that soils may become hydrophobic, or water-repellent. Water repellent soil retards water infiltration into the soil matrix, and often renders entire areas of the upper layers of the soil substrate essentially impervious to water penetration. This, in turn, makes it difficult to deliver aqueous insecticides to below-ground pests. Further, under rainfall or irrigation conditions, undesirable environmental consequences can result from hydrophobic soils, including surface runoff of water and treatments (e.g., pesticides and fertilizers) into pristine areas or reservoirs of potable water. In addition, it is possible for treatments to flow through the “fingers” that often attend water-repellent soil into the ground water table, thus increasing the risk of ground water contamination.

### BRIEF SUMMARY OF THE INVENTION

It is therefore desirable to provide an insecticide formulation that more efficiently and effectively delivers lethal doses of insecticide to below-surface pests such as white grubs.

The present invention is a soil-applied composition for controlling turf-damaging pests. The composition includes a neonicotinoid insecticide, such as an imidacloprid-based insecticide, a nonionic surfactant, and an aqueous solvent. The nonionic surfactant is preferably present in an amount in excess of about 50% by weight. More preferably, the ratio of nonionic surfactant to neonicotinoid insecticide is at least about 2:1. Suitable surfactants include, without limitation, nonyl phenol ethoxylates, alcohol ethoxylates, organosilicones, alkyl polyglycosides, block co-polymers, and other polymeric surfactants. The surfactant may also be a combination thereof. In some embodiments of the invention, the composition may include a bio-stimulant to aid in turf recovery, a humectant, or both a bio-stimulant and a humectant. One preferred composition includes about 5.4% neonicotinoid insecticide and about 94.6% surfactant. Another preferred composition includes about 31.25% neonicotinoid insecticide and about 68.75% nonionic surfactant.

An effective amount of the composition may be applied to a region of soil or turf in order to control turf-damaging pests, such as white grubs. One preferred treatment includes applying about 64 ounces of the composition per acre of soil. Another preferred treatment includes applying the composition so as to deliver about 20 ounces of neonicotinoid insecticide per acre of soil and about 1 ounce of surfactant per 1000 ft² of soil.

An advantage of the present invention is that the insecticide is more quickly and readily moved into the soil solution, thereby mitigating the effects of photodegradation and delivering a higher percentage of active ingredient to the control zone.

Another advantage is that the insecticide is more evenly distributed into the control zone, improving performance through improved distribution of the active ingredient.

Yet another advantage of the present invention is that the insecticide is more readily available in the soil solution, which improves contact activity and provides faster, more efficient uptake of the insecticide by the plant.

A further advantage of the present invention is that it hastens turf recovery through residual soil moisture and microbial enhancement during a time when damaged plants struggle for moisture and nutrient uptake.

The foregoing and other aspects, features, details, utilities, and advantages of the present invention will be apparent from reading the following description and claims, and from reviewing the accompanying drawings.

### DETAILED DESCRIPTION OF THE INVENTION

The present invention provides a soil-applied composition for controlling turf-damaging pests, such as white grubs. The composition is an aqueous solution of a neonicotinoid insecticide, a surfactant, and an aqueous solvent. Preferably, the neonicotinoid insecticide is an imidacloprid-based insecticide, such as Mallet™ 2F, which is an approximately 21.4% imidacloprid liquid insecticide offered by Nufarm Americas Inc. (Burr Ridge, Ill.).

As one of ordinary skill in the art will recognize, the surfactant acts to reduce the surface tension of the aqueous solvent such that the insecticide can better penetrate through the thatch and wet into the soil where the pests are located and where the insecticide may be taken up by the plant roots.

The surfactant is preferably a nonionic surfactant (the term “nonionic surfactant” includes polymeric surfactants). Suitable nonionic surfactants include, without limitation, alcohol ethoxylates, nonylphenol ethoxylates, alkyl polyglycosides, organosilicones, alkoxylated polyols, co-polymers of polyethylene and polypropylene glycols, nonionic polyol, and any combinations thereof. It is also contemplated that the surfactant may be an anionic surfactant, such as ammonium lauryl ethyl sulfates, sodium lignosulfonates, and sodium alkyl sulfosuccinates.

Preferred nonionic surfactants include blends of alkyl polyglycoside and glycerin. Other preferred surfactants include blends of alkyl polyglycoside, block co-polymers of polypropylene oxide, and ethylene oxide. Another particularly preferred nonionic surfactant is a proprietary blend of nonionic carbohydrate surfactants, polyoxyethylene-polyoxypropylene glycol, and polydimethylsiloxane commercially available through Kalo, Inc. (Overland Park, Kans.) under the brand name Tournament Ready. Yet another preferred surfactant is a blended nonionic matrix flow soil surfactant with alkoxylated polyols commercially available through Aquatrols Corporation (Paulsboro, N.J.) under the brand name Primer Select. Another preferred surfactant is a blend of nonionic surfactants commercially available through Lesco, Inc. (Cleveland, Ohio) under the brand name Lesco Flo.

The following table further identifies a number of commercially available products that may also be used in conjunction with the present invention.

| Brand | Manufacturer | General Use Rate | |
|---|---|---|---|
| Aqueduct | Aquatrols Corporation | 4-8 | oz per 1000 square feet |
| Brilliance | J. R. Simplot Company | 8-16 | oz per 1000 square feet |
| Cascade Plus | Precision Laboratories | 8 | oz per 1000 square feet |
| Hydro-Wet | Kalo, Inc. | 2-8 | oz per 1000 square feet |
| Lesco Flo | Lesco, Inc. | 8-16 | oz per 1000 square feet |
| Naiad | Naiad Company | 2-16 | oz per 1000 square feet |
| Primer Select | Aquatrols Corporation | 2-9 | oz per 1000 square feet |
| TriCure | Mitchell Products | 2-12 | oz per 1000 square feet |

One of ordinary skill in the art will recognize that surfactants mix and remain stable with pesticide concentrate formulations when used at levels of about 20% or less. In some cases, surfactants may be used at levels up to about 40%. Mallet™ 2F, a suspension concentrate, however, exhibits the unusual and unexpected property of exhibiting compatibility, and a stable suspension, with a high loading of nonionic surfactant between about 64% and about 97%. These mixtures remain homogenous at temperatures between about 0 degrees C. and about 54 degrees C. for a minimum of one year. During this period, little (e.g., statistically insignificant) or no sedimentation or degradation of physical properties, such as viscosity, particle size, and dispersion, occurs. Moreover, the mixture freely dilutes with water for application to soil.

Thus, preferred formulations according to the present teachings include mixtures of surfactants and neonicotinoid insecticide. Preferably, the formulation includes about 1% to about 50% neonicotinoid insecticide and about 50% to about 99% nonionic surfactant. More preferably, the formulation includes about 3% to about 35% neonicotinoid insecticide and about 65% to about 97% nonionic surfactant. Most preferably, the formulation includes about 4% to about 6% neonicotinoid insecticide and about 94% to about 96% nonionic surfactant.

One suitable formulation according to the present teachings includes about 33% Mallet™ 2F insecticide and about 66% Tournament Ready surfactant. In addition, the formulation includes about 0.15% Rhodopol 23 (xanthan gum), about 0.54% Propylene Glycol, about 0.06% Proxel GXL, and about 0.25% Polysiloxane. The table below illustrates the properties of this exemplary formulation at initial formulation and after one year at ambient:

| | INITIAL | |
|---|---|---|
| | FORMULATION | ONE YEAR AT AMBIENT |
| Appearance | White suspension | White suspension |
| Sediment | None | None |
| Viscosity (cps) | 1,880 | 1,950 |
| Suspensibility (%) | 95 | 93 |

In some embodiments, the composition includes additional adjuvants. For example, the composition may include a humectant to facilitates prolonged soil moisture following application of the composition. Suitable humectants include, but are not limited to, EO/PO co-block and reverse block polymers, natural polymers, polyacrylamide derivatives, glycerin, natural starches and gums, and any combinations thereof. As should be appreciated by one of ordinary skill in the art, humectants help retain and hold moisture in the soil matrix so that the insecticide active ingredient may be more readily taken up by the plants and/or may be more readily contacted by the pests. In addition, the humectant advantageously aids in the plant health recovery process by making soil moisture and nutrients more readily available for damaged plants. Similarly, the composition may further include a bio-stimulant, such as microbial feed-stock designed to stimulate the naturally occurring soil microbes that contribute to a healthy plant environment, to aid in the plant health recovery process.

The invention will be further described in connection with exemplary compositions and methods of controlling turf-damaging pests.

Formulation 1

A first aqueous pest control composition includes 5.4% Mallet™ 2F and 94.6% Tournament Ready FC, commercially available from Kalo, Inc. The composition is inverted multiple times and shaken vigorously to form a milky solution.

Formulation 2

Another embodiment of the aqueous pest control composition includes 31.25% Mallet™ 2F and 68.75% Tournament Ready FC, commercially available from Kalo, Inc. Standard use rates for imidacloprid range from about 0.313 to about 0.408 lbs. of active imidacloprid ingredient per acre, while the standard use rates for most soil wetting agents (e.g., surfactants) range from about 1 ounce to about 16 ounces per 1000 ft². Formulation 2, when applied at a rate of about 64 ounces per acre of soil, will deliver about 20 ounces of imidacloprid per acre, or about 0.313 lbs. of active ingredient, and about 1.01 ounces per 1000 ft² of surfactant.

Treatment Evaluation

Formulation 2, applied at a rate of about 64 ounces/acre, is compared to a control formulation of 100% Mallet™ 2F applied at a rate of about 20 ounces/acre. Treatments are carefully measured and mixed into a treated spray solution. The treatment solutions are mixed to simulate x-rates of Formulation 2 and the control formulation at an application volume of 20 GPA per acre.

In a first experiment, the treatment solutions are then poured through a soil profile held fixed in a filter containment, allowing solution to flow through, but not allowing soil particles to leave the filter containment. Soil weights are recorded prior to treatment and then 60 seconds after treatment. The table below illustrates the results of an experiment:

| | Prior (grams) | After (grams) | % Increase |
|---|---|---|---|
| Control Formulation | 36 | 42 | 16 |
| Formulation 2 | 36 | 55 | 52 |

As seen from the above results, soil treated with Formulation 2 retained 31% more moisture than soil treated with the control formulation. The soil treated with the control formulation was very dry and poorly wetted, while the soil treated with Formulation 2 was completely wetted out.

In a second experiment, 15 ml of Formulation 2 and the control formulation are sprayed onto equalized piles of soil of about 35 grams each and then observed. The control formulation wetted just the surface of the soil, while Formulation 2 penetrated and completely wet out the entire soil sample.

A third experiment evaluated the efficacy of various treatment formulations in controlling the Green June Beetle in Bermuda grass. The experiment was designed as a randomized complete block with four replications. The table below illustrates the total number of live grubs approximately two months after treatment was applied.

| | | Total Number of Live | | | | Average |
|---|---|---|---|---|---|---|
| | Rate | Grubs/Replication | | | | Live |
| Formulation | Imidacloprid | I | II | III | IV | Grubs |
| Control | | 19.00 | 10.00 | 20.00 | 15.00 | 16.00 |
| Mallet 2F (with 21.4% imidacloprid) | 0.4 lb ai/A | 0.00 | 6.00 | 0.00 | 0.00 | 1.50 |
| NUP 07030 (Mallet 2F plus 66.6% | 0.4 lb ai/A | 0.00 | 0.00 | 0.00 | 0.00 | 0.00 |
| Kalo penetrant with 7.1% | | | | | | |
| imidacloprid) | | | | | | |
| NUQ-05054 (Slow Release suSCon | 0.4 lb ai/A | 4.00 | 1.00 | 3.00 | 0.00 | 2.00 |
| Granule with 5% imidacloprid) | | | | | | |
| 0.2% Mallet plus fertilizer 19-3-4 | 0.4 lb ai/A | 0.00 | 2.00 | 0.00 | 4.00 | 1.50 |
| (with 0.2% imidacloprid) | | | | | | |

Although several embodiments of this invention have been described above with a certain degree of particularity, those skilled in the art could make numerous alterations to the disclosed embodiments without departing from the spirit or scope of this invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A soil-applied composition for controlling turf-damaging pests, the composition comprising:
an neonicotinoid insecticide;
a nonionic surfactant; and
an aqueous solvent,
wherein the nonionic surfactant is present in an amount in excess of about 50% by weight.

2. The composition according to claim 1, wherein the neonicotinoid insecticide comprises imidacloprid.

3. The composition according to claim 1, wherein the nonionic surfactant is selected from the group consisting of: nonyl phenol ethoxylates, alcohol ethoxylates, organosilicones, alkyl polyglycosides, block co-polymers, and any combinations thereof.

4. The composition according to claim 1, further comprising a bio-stimulant to aid in turf recovery.

5. The composition according to claim 1, further comprising a humectant.

6. The composition according to claim 1, wherein the ratio of nonionic surfactant to neonicotinoid insecticide is at least about 2 to 1.

7. A method of controlling turf-damaging pests, comprising:
preparing an aqueous pest control composition comprising a neonicotinoid insecticide and a nonionic surfactant; and
applying an effective amount of the aqueous pest control composition to a region of soil.

8. The method according to claim 7, wherein the neonicotinoid insecticide comprises an imidacloprid-based insecticide.

9. The method according to claim 7, wherein the nonionic surfactant comprises a polymeric surfactant.

10. The method according to claim 7, wherein the nonionic surfactant comprises alkyl polyglycoside and glycerin.

11. The method according to claim 7, wherein the aqueous pest control composition further comprises a bio-stimulant to aid in turf recovery.

12. The method according to claim 7, wherein the aqueous pest control composition further comprises a humectant.

13. The method according to claim 7, wherein the aqueous pest control composition comprises from about 1% to about 50% neonicotinoid insecticide and about 50% to about 99% nonionic surfactant.

14. The method according to claim 7, wherein the aqueous pest control composition comprises from about 3% to about 35% neonicotinoid insecticide and about 65% to about 97% nonionic surfactant.

15. The method according to claim 14, wherein the aqueous pest control composition comprises about 33% neonicotinoid insecticide and about 66% nonionic surfactant.

16. The method according to claim 7, wherein the aqueous pest control composition comprises from about 4% to about 6% neonicotinoid insecticide and about 94% to about 96% nonionic surfactant.

17. The method according to claim 7, wherein the aqueous pest control composition comprises about 31.25% neonicotinoid insecticide and about 68.75% nonionic surfactant.

18. The method according to claim 7, wherein the aqueous pest control composition comprises about 5.4% neonicotinoid insecticide and about 94.6% nonionic surfactant.

19. The method according to claim 7, wherein the step of applying an effective amount of the aqueous pest control composition to a region of soil comprises applying about 64 ounces of the aqueous pest control composition per acre of soil.

20. The method according to claim 7, wherein the step of applying an effective amount of the aqueous pest control composition to a region of soil comprises applying about 20 ounces of neonicotinoid insecticide per acre of soil and about 1 ounce of nonionic surfactant per 1000 ft² of soil.

21. A method of controlling turf-damaging pests, comprising:
formulating a pest control composition consisting essentially of a neonicotinoid insecticide and a surfactant; and
applying an effective amount of the pest control composition to a region of soil.

22. The method according to claim 21, wherein the effective amount delivers about 20 ounces of neonicotinoid insecticide per acre of soil and about 1 ounce of surfactant per 1000 ft² of soil.
